(19) United States
(12) Patent Application Publication
(10) Pub. No.: US 2024/0236902 A1
(43) Pub. Date: Jul. 11, 2024

(54) METHOD AND APPARATUS FOR PROVIDING UE POLICY IN MOBILE WIRELESS COMMUNICATION SYSTEM

(71) Applicant: Samsung Electronics Co., Ltd., Gyeonggi-do (KR)

(72) Inventors: Dongyeon KIM, Gyeonggi-do (KR); Jicheol LEE, Gyeonggi-do (KR)

(21) Appl. No.: 18/405,373

(22) Filed: Jan. 5, 2024

(30) Foreign Application Priority Data
Jan. 5, 2023 (KR) 10-2023-0001885
Feb. 8, 2023 (KR) 10-2023-0016702

(51) Int. Cl. H04W 60/00; H04W 48/16

(52) U.S. Cl. CPC H04W 60/00; H04W 48/16

(57) ABSTRACT

The disclosure relates to a 5G or 6G communication system for supporting a higher data transmission rate. A method performed by an access and mobility management function (AMF) entity in a wireless communication system is provided. The method comprises receiving, from a user equipment (UE), a registration request for fifth generation system (5GS), wherein the registration request includes information on a UE policy container and an indicator that the UE is moving from an evolved packet system (EPS), transmitting, to a first policy control function (PCF) entity for the UE, a first request message for first access and management (AM) policy association based on the registration request, wherein the first request message includes the indicator and receiving, from the first PCF entity, a message including an identifier (ID) of a second PCF entity for the EPS based on the first request message.

### CROSS-REFERENCE TO RELATED APPLICATION(S)

This application is based on and claims priority under 35 U.S.C. § 119 to Korean Patent Application Nos. 10-2023-0001885 and 10-2023-0016702, which were filed in the Korean Intellectual Property Office on Jan. 5, 2023, and Feb. 8, 2023, the entire disclosure of each of which is incorporated herein by reference.

### BACKGROUND

### 1. Field

The disclosure relates generally to a mobile communication system (or a wireless communication system and, more specifically, to a method and an apparatus for providing user equipment (UE) policy information in a mobile communication (or a wireless communication system).

### 2. Description of Related Art

5^{th} generation (5G) mobile communication technologies define broad frequency bands such that relatively higher transmission rates and new services are possible, and can be implemented in “sub 6 GHz” bands such as 3.5 GHz, as well as in “above 6 GHz” bands, which may be referred to as mmWave, including 28 GHz and 39 GHz. In addition, it has been considered to implement 6^{th} generation (6G) mobile communication technologies (i.e., beyond 5G systems) in terahertz (THz) bands (e.g., 95 GHz to 3 THz bands) in order to accomplish transmission rates fifty times faster than 5G mobile communication technologies and ultra-low latencies one-tenth of 5G mobile communication technologies.

Since the beginning of the development of 5G mobile communication technologies, in order to support services and to satisfy performance requirements in connection with enhanced mobile broadband (eMBB), ultra reliable low latency communications (URLLC), and massive machine-type communications (mMTC), there has been ongoing standardization regarding beamforming and massive multi-input multi-output (MIMO) for mitigating radio-wave path loss and increasing radio-wave transmission distances in mmWave, supporting numerologies (e.g., operating multiple subcarrier spacings) for efficiently utilizing mmWave resources and dynamic operation of slot formats, initial access technologies for supporting multi-beam transmission and broadbands, definition and operation of a bandwidth part (BWP), new channel coding methods such as a low density parity check (LDPC) code for larger amounts of data transmission and a polar code for highly reliable transmission of control information, layer 2 (L2) pre-processing, and network slicing for providing a dedicated network specialized to a specific service.

Currently, there are ongoing discussions regarding improvement and performance enhancement of initial 5G mobile communication technologies in view of services to be supported by future 5G mobile communication technologies including physical layer standardization regarding technologies such as vehicle-to-everything (V2X) for aiding driving determination by autonomous vehicles based on information regarding positions and states of vehicles transmitted by the vehicles and for enhancing user convenience, new radio unlicensed (NR-U) aimed at system operations conforming to various regulation-related requirements in unlicensed bands, NR UE power saving, a non-terrestrial network (NTN), which is UE-satellite direct communication for providing coverage in an area in which communication with terrestrial networks is unavailable, and positioning.

There is also ongoing standardization in air interface architecture/protocol regarding technologies such as industrial Internet of things (IIoT) for supporting new services through interworking and convergence with other industries, integrated access and backhaul (IAB) for providing a node for network service area expansion by supporting a wireless backhaul link and an access link in an integrated manner, mobility enhancement including conditional handover and dual active protocol stack (DAPS) handover, and two-step random access for simplifying random access procedures (2-step RACH for NR).

There is also ongoing standardization in system architecture/service regarding a 5G baseline architecture (e.g., service based architecture or service based interface) for combining network functions virtualization (NFV) and software-defined networking (SDN) technologies, and mobile edge computing (MEC) for receiving services based on UE positions.

As 5G mobile communication systems are commercialized, the number of devices that will be connected to communication networks is expected to exponentially increase, and it is accordingly expected that enhanced functions and performances of 5G mobile communication systems and integrated operations of connected devices will be necessary. To this end, new research is scheduled in connection with extended reality (XR) for efficiently supporting augmented reality (AR), virtual reality (VR), mixed reality (ME), etc., 5G performance improvement and complexity reduction by utilizing artificial intelligence (AI) and machine learning (ML), AI service support, metaverse service support, and drone communication.

Furthermore, such development of 5G mobile communication systems will serve as a basis for developing new waveforms for providing coverage in THz bands of 6G mobile communication technologies, multi-antenna transmission technologies such as full dimensional MIMO (FD-MIMO), array antennas and large-scale antennas, metamaterial-based lenses and antennas for improving coverage of THz band signals, high-dimensional space multiplexing technology using orbital angular momentum (OAM), and reconfigurable intelligent surface (RIS), as well as full-duplex technology for increasing frequency efficiency of 6G mobile communication technologies and improving system networks, AI-based communication technology for implementing system optimization by utilizing satellites and AI from the design stage and internalizing end-to-end AI support functions, and next-generation distributed computing technology for implementing services at levels of complexity exceeding the limit of UE operation capability by utilizing ultra-high-performance communication and computing resources.

As communication systems are developed, the demand for smoothly providing a policy of a UE in a mobile communication system, specifically, a complex communication system, has increased.

The above information is presented as background information only to assist with an understanding of the disclosure. No determination has been made, and no assertion is made, as to whether any of the above might be applicable as prior art with regard to the disclosure.

### SUMMARY

A 5G system (5GS) corresponding to a network that has been commercialized and a long-term evolution (LTE) and LTE-advanced (LTE-A) system corresponding to a system which currently provides a mobile communication service are all mobile communication systems which provide packet-based services. Such a 5GS has been developed to support interworking with an evolved packet system (EPS) based on the LTE and LTE-A. In the disclosure, the 5GS may be referred to as a 5G system. In the 5G system, a 5G core (5GC) network may provide a UE with a UE policy.

In the 5G system, interworking between the EPS and the 5GS can be supported for a UE capable of using wireless communication through the 5GS and/or the EPS. When such a UE is connected to the network of the EPS and then connected to the network of the EPS of the 5GS (that is, when the UE moves from the EPS to the 5GS), an access and mobility management function (AMF) of the 5GS selects a new policy control function (PCF) for the UE in a situation in which there is an old PCF having provided UE policy information to the UE in the EPS. In this case, multiple PCFs of the old PCF and the new PCF exist for a single UE, and thus a conflict may occur in UE policy information provided to the UE.

Accordingly, an aspect of the disclosure is to provide a method and an apparatus for selecting a PCF in a wireless communication system supporting interworking between different networks.

Another aspect of the disclosure is to provide a method and an apparatus for efficiently/stably selecting a PCF when a network connection of a UE moves from an EPS to a 5GS in a wireless communication system supporting interworking between the EPS and the 5GS.

A method performed by an access and mobility management function (AMF) entity in a wireless communication system is provided. The method comprises receiving, from a user equipment (UE), a registration request for fifth generation system (5GS), wherein the registration request includes information on a UE policy container and an indicator that the UE is moving from an evolved packet system (EPS), transmitting, to a first policy control function (PCF) entity for the UE, a first request message for first access and management (AM) policy association based on the registration request, wherein the first request message includes the indicator and receiving, from the first PCF entity, a message including an identifier (ID) of a second PCF entity for the EPS based on the first request message.

An access and mobility management function (AMF) entity in a wireless communication system is provided. The AMF entity comprises a transceiver and a controller coupled with the transceiver and configured to receive, from a user equipment (UE), a registration request for fifth generation system (5GS), wherein the registration request includes information on a UE policy container and an indicator that the UE is moving from an evolved packet system (EPS), transmit, to a first policy control function (PCF) entity for the UE, a first request message for first access and management (AM) policy association based on the registration request, wherein the first request message includes the indicator, and receive, from the first PCF entity, a message including an identifier (ID) of a second PCF entity for the EPS based on the first request message.

A method performed by a first policy control function (PCF) entity in a wireless communication system is provided The method comprises receiving, from an access and mobility management function (AMF) entity, a first request message for first access management (AM) policy association based on a registration request including information on a UE policy container and an indicator that a user equipment (UE) is moving from an evolved packet system (EPS) and transmitting, to the AMF entity, a message including an identifier (ID) of a second PCF entity for the EPS based on the first request message, wherein the first request message includes the indicator.

A first policy control function (PCF) entity in a wireless communication system, the first PCF entity comprises a transceiver and a controller coupled with the transceiver and configured to receive, from an access and mobility management function (AMF) entity, a first request message for first access management (AM) policy association based on a registration request including an indicator that a user equipment (UE) is from an evolved packet system (EPS) and information on a UE policy container, and transmit, to the AMF entity, a message including an identification (ID) of a second PCF entity for the EPS based on the first request message, wherein the first request message includes the indicator that the UE is from the EPS.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a network structure and an interface of a 5GS according to an embodiment;

FIG. 2 illustrates a network structure and an interface of a wireless communication system supporting interworking between an EPS and a 5GS according to an embodiment;

FIG. 3 illustrates a network structure and an interface related to a policy control and charging control system of a 5GS according to an embodiment;

FIG. 4 illustrates a network access procedure in a wireless communication system supporting interworking between an EPS and a 5GS supporting UE policy management according to an embodiment;

FIG. 5 is a signal flow diagram illustrating a procedure for resuming a connection with a PCF used in an EPS when a UE moves core network (CN) access from the EPS to a 5GS in a wireless communication system supporting interworking between the EPS and the 5GS according to an embodiment;

FIG. 6 is a signal flow diagram illustrating a procedure for resuming a connection with a PCF used in an EPS when a UE moves CN access from the EPS to a 5GS in a wireless communication system supporting interworking between the EPS and the 5GS according to an embodiment;

FIG. 7 is a signal flow diagram illustrating a procedure for resuming a connection with a PCF used in an EPS when a UE moves CN access from the EPS to a 5GS in a wireless communication system supporting interworking between the EPS and the 5GS according to an embodiment;

FIG. 8 illustrates a network entity according to an embodiment;

FIG. 9 illustrates a base station (BS) according to an embodiment; and

FIG. 10 illustrates a UE according to an embodiment.

### DETAILED DESCRIPTION

Hereinafter, the disclosure will be described in detail by explaining various embodiments of the disclosure with reference to the attached drawings.

In describing embodiments of the disclosure, descriptions related to technical contents well-known in the art and not associated directly with the disclosure will be omitted. Such an omission of unnecessary descriptions is intended to prevent obscuring of the main idea of the disclosure and more clearly transfer the main idea.

For similar reasoning, in the accompanying drawings, some elements may be exaggerated, omitted, or schematically illustrated. Further, the size of each element may not completely reflect the actual size. In the drawings, identical or corresponding elements may be provided with the same or similar reference numerals.

Various advantages and features of the disclosure and ways to achieve them will be apparent by making reference to embodiments as described below in detail in conjunction with the accompanying drawings. However, the disclosure is not limited to the embodiments set forth below, but may be implemented in various different forms. The following embodiments are provided only to completely disclose the disclosure and inform those skilled in the art of the scope of the disclosure, and the disclosure is defined only by the scope of the appended claims.

Each block of the flowchart illustrations, and combinations of blocks in the flowchart illustrations, can be implemented by computer program instructions. These computer program instructions can be provided to a processor of a general purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Furthermore, each block of the flowchart illustrations may represent a module, segment, or portion of code, which includes one or more executable instructions for implementing the specified logical function(s).

In some alternative implementations, the functions noted in the blocks may occur out of the order. For example, two blocks shown in succession may in fact be executed substantially concurrently or the blocks may sometimes be executed in the reverse order, depending upon the functionality involved.

As used herein, the “unit” refers to a software element or a hardware element, such as a field programmable gate array (FPGA) or an application specific integrated circuit (ASIC), which performs a predetermined function. However, “unit” does not always have a meaning limited to software or hardware. A “unit” may be constructed either to be stored in an addressable storage medium or to execute one or more processors. Therefore, the term “unit” includes, e.g., software elements, object-oriented software elements, class elements or task elements, processes, functions, properties, procedures, sub-routines, segments of a program code, drivers, firmware, micro-codes, circuits, data, database (DB), data structures, tables, arrays, and parameters. The elements and functions provided by the “unit” may be either combined into a smaller number of elements, or a “unit”, or divided into a larger number of elements, or a “unit”. Moreover, the elements and “units” or may be implemented to reproduce one or more central processing units (CPUs) within a device or a security multimedia card.

Hereinafter, exemplary embodiments of the disclosure will be described in detail with reference to the accompanying drawings. It should be noted that, in the accompanying drawings, the same or like elements are designated by the same or like reference signs as much as possible. In addition, it should be noted that the accompanying drawings of the disclosure as shown below are provided merely to help the understanding of the disclosure, and the disclosure is not limited by the forms and configurations illustrated in the drawings of the disclosure. Furthermore, a detailed description of known functions or configurations that may make the subject matter of the disclosure unclear will be omitted. It should be noted that, in the following description, only parts necessary for the understanding of the disclosure will be explained, and a description of the other parts will be omitted so as not to make the subject matter of the disclosure obscure. Moreover, various embodiments of the disclosure will be described using terms and names employed in some communication standards (e.g., 3rd generation partnership project (3GPP)), but this is only an example for the illustrative description of the disclosure. Various embodiments of the disclosure may be easily applied to other communication systems through modifications. As used herein, each of such phrases as “A/B,” “A and/or B,” “A or B,” “at least one of A and B,” “at least one of A or B,” “A, B, or C,” “at least one of A, B, and C,” and “at least one of A, B, or C” may include all possible combinations of the items enumerated together in a corresponding one of the phrases. Numerical terms, such as “a first”, “a second”, “the first”, and “the second” may be used to simply distinguish a corresponding element from another, and does not limit the elements in other aspect (e.g., importance or order). In the following description, a BS is an entity that allocates resources to terminals, and may include at least one of a radio access network (RAN) node, a gNode B (or a next generation node B (gNB)), an eNode B (or an evolved node B (eNB)), a Node B, a wireless access unit, a BS controller, and a node on a network. Herein, the term “eNB” may be interchangeably used with the term “gNB”. That is, a BS described as an “eNB” may indicate a “gNB”.

In the following description, a terminal may include a UE, a mobile station (MS), a cellular phone, a smartphone, a computer, or a multimedia system capable of performing communication functions.

Of course, examples of the BS and the terminal are not limited to those described above.

The disclosure may be applied to 3GPP NR (i.e., 5G mobile communication standards). In addition, the disclosure may be applied to intelligent services (e.g., smart homes, smart buildings, smart cities, smart cars or connected cars, healthcare, digital education, retail business, security and safety-related services, etc.) based on 5G communication technology and Internet of things (IoT)-related technology. Accordingly, the term “terminal” may refer to a mobile phone, an NR-IoT, a sensor, or other wireless communication devices.

A wireless communication system is advancing to a broadband wireless communication system for providing high-speed and high-quality packet data services using communication standards, such as high-speed packet access (HSPA) of 3GPP, LTE, evolved universal terrestrial radio access (E-UTRA), LTE-A, LTE-Pro, high-rate packet data (HRPD) of 3GPP2, ultra-mobile broadband (UMB), IEEE 802.16e, etc., as well as typical voice-based services.

For example, an LTE system employs an orthogonal frequency division multiplexing (OFDM) scheme in a downlink (DL) and employs a single carrier frequency division multiple access (SC-FDMA) scheme in an uplink (UL). The UL indicates a radio link through which a UE (or an MS) transmits data or control signals to a BS (or eNode B), and the DL indicates a radio link through which the BS transmits data or control signals to the UE. The above multiple access scheme separates data or control information of respective users by allocating and operating time-frequency resources for transmitting the data or control information for each user so as to avoid overlapping each other, i.e., to establish orthogonality.

Since a 5G communication system, which is a post-LTE communication system, should freely reflect various requirements of users, service providers, etc., services satisfying various requirements should be supported. The services considered in the 5G communication system include eMBB communication, mMTC, URLLC, etc.

eMBB aims at providing a higher data rate than that supported by LTE, LTE-A, or LTE-Pro. For example, in the 5G communication system, eMBB should provide a peak data rate of 20 Gbps in the DL and a peak data rate of 10 Gbps in the UL for a single BS. Furthermore, the 5G communication system should provide an increased user-perceived data rate to the UE, as well as the maximum data rate. In order to satisfy such requirements, transmission/reception technologies including a further enhanced MIMO transmission technique should be improved. In addition, the data rate for the 5G communication system may be obtained using a frequency bandwidth more than 20 MHz in a frequency band of 3 to 6 GHz or 6 GHz or more, instead of transmitting signals using a transmission bandwidth up to 20 MHz in a band of 2 GHz used in LTE.

In addition, mMTC is being considered to support application services such as IoT in a 5G communication system. mMTC should support the connection of a large number of UEs in a cell, enhancement coverage of UEs, improved battery time, a reduction in the cost of a UE, etc., in order to effectively provide the IoT. Since IoT provides communication functions while being provided to various sensors and various devices, it should support a large number of UEs (e.g., 1,000,000 UEs/km2) in a cell. In addition, the UEs supporting mMTC may require wider coverage than those of other services provided by the 5G communication system because the UEs are likely to be located in a shadow area, such as a basement of a building, which is not covered by the cell due to the nature of the service. Accordingly, a UE supporting mMTC should be inexpensive, and have a very long battery life-time, such as 10 to 15 years, because it is often difficult to frequently replace the battery of the UE.

URLLC, which is a cellular-based mission-critical wireless communication service, may be used for remote control for robots or machines, industrial automation, unmanned aerial vehicles, remote health care, emergency alert, etc. URLLC should provide communication with ultra-low latency and ultra-high reliability. For example, a service supporting URLLC should satisfy an air interface latency of less than 0.5 ms, and also a packet error rate of 10-5 or less. Therefore, for the services supporting URLLC, a 5GS should provide a transmit time interval (TTI) shorter than those of other services, and may require a design for assigning a large number of resources in a frequency band in order to secure reliability of a communication link.

The above-described three services considered in the 5G communication system, i.e., eMBB, URLLC, and mMTC, may be multiplexed and transmitted in a single system. In order to satisfy different requirements of the respective services, different transmission/reception techniques and transmission/reception parameters may be used between the services. However, the above mMTC, URLLC, and eMBB are merely examples of different types of services, and service types to which the disclosure is applied are not limited to the above examples.

In the following description of embodiments of the disclosure, an LTE, LTE-A, LTE Pro, 5G (or NR), or 6G system will be described by way of example, but the embodiments of the disclosure may be applied to other communication systems having similar backgrounds or channel types. Furthermore, based on determinations by those skilled in the art, the embodiments of the disclosure may be applied to other communication systems through some modifications without significantly departing from the scope of the disclosure.

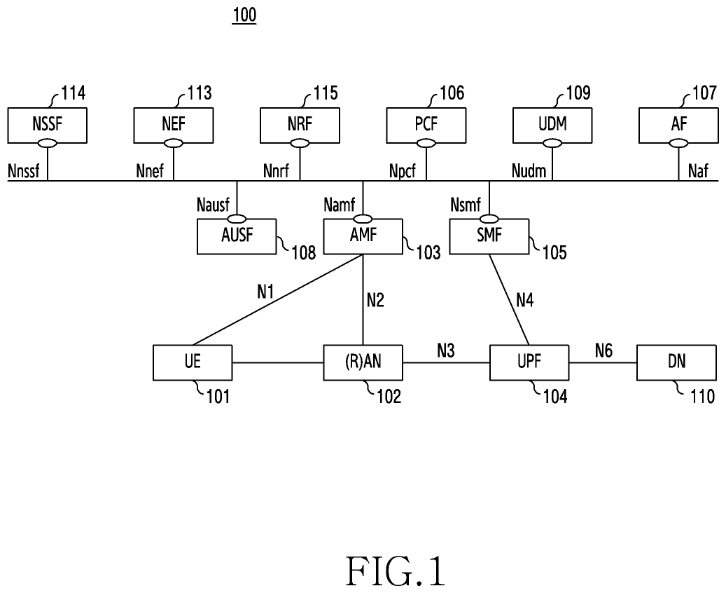

In the disclosure, a network technology may refer to a standard (e.g., TS 23.501, TS 23.502, TS 23.503, etc.) defined by International Telecommunication Union (ITU) or 3GPP, and elements, e.g., those included in a network structure of FIG. 1, which will be described below, may be physical entities, software performing an individual function, or hardware combined with software.

In the drawings, reference numerals indicated as Nx such as N1, N2, N3, and . . . indicate interfaces known among network functions (NFs) in a 5G CN.

FIG. 1 illustrates a network structure and an interface of a 5GS according to an embodiment. For example, a network entity included in the network structure of the 5GS of FIG. 1 may include an NF according to system implementation, and may be referred to as a network node.

Referring to FIG. 1, the network structure of the 5GS may include various network entities. For example, the 5GS includes an authentication server function (AUSF) 108, an AMF 103, a session management function (SMF) 105, a PCF 106, an application function (AF) 107, a unified data management (UDM) 109, a data network (DN) 110, a network exposure function (NEF) 113, a network slicing selection function (NSSF) 114, an edge application server domain repository (EDR) (not shown), an edge application server (EAS) (not shown), an EAS discovery function (EASDF) (not shown), a user plane function (UPF) 104, a ((R)AN) 102, and a UE (or terminal) 101.

Hereinafter, described functions are provided as an example, and the respective NFs may perform more or fewer functions. For example, the respective NFs of the 5GS may support the following functions.

The AUSF 108 may process and store data for authentication of the UE 101.

The AMF 103 may provide a function for access and mobility (AM) management in units of UEs, and a single UE may be basically connected to a single ANF. Specifically, the AMF 103 may support functions such as signaling between CN nodes for mobility among 3GPP access networks, termination of a RAN control plane (CP) interface (i.e., N2 interface), termination of a non-access stratum (NAS) signaling (N1), NAS signaling security (NAS ciphering and integrity protection), AS security control, registration management (registration area management), connection management, idle mode UE reachability (e.g., including controlling and performing of paging retransmission), mobility management control (subscription and policy), supporting intra-system mobility and inter-system mobility, supporting network slicing, selecting an SMF, lawful intercept (LI) (e.g., with respect to an AMF event and an interface to an LI system), providing delivery of a session management (SM) message between a UE and an SMF, a transparent proxy for routing an SM message, access authentication, access authorization including checking of the right of roaming, providing delivery of a short message service (SMS) message between a UE and an SMS function (SMSF), a security anchor function (SAF), and/or security context management (SCM). Some or all of the functions of an AMF 103 may be supported in a single instance of a single AMF

The DN 110 may include an operator service, an Internet access or 3rd party service, etc. The DN 110 may transmit a DL protocol data unit (PDU) to the UPF 104, or receive, from the UPF 104, a PDU transmitted from the UE 101.

The PCF 106 may receive information on a packet flow from an application server, and provide a function of determining a policy of mobility management, SM, etc. Specifically, the PCF 106 may support functions such as supporting a unified policy framework to control network operations, providing policy rules so that a CP function (e.g., an AMF, an SMF, etc.) can implement the policy rules, and implementing a front end (FE) for accessing related subscription information to determine a policy in a user data repository (UDR).

The SMF 105 may provide an SMF, and when the UE 101 has multiple sessions, the sessions may be managed by SMFs different from each other. Specifically, the SMF 105 may support functions such as SM (e.g., establishing, correcting, and releasing a session while including maintaining a tunnel between nodes of the UPF 104 and the (R)AN 102), allocating and managing a UE IP address (selectively including authentication), selecting and controlling a user plane (UP) function, configuring traffic steering for routing traffic from the UPF 104 to an appropriate destination, termination of an interface for PCFs, performing the control part of a policy and quality of service (QoS), LI (with respect to an SM event and an interface to an LI system), termination of an SM part of an NAS message, DL data notification, an initiator of access network (AN)-specific SM information (transferring to the (R)AN 102 through N2 via the AMF 103), determining a session and service continuity (SSC) mode, and a roaming function. Some or all of the functions of the SMF 105 may be supported in a single SMF.

The UDM 109 may store user subscription data, policy data, etc. The UDM 109 may include two parts, i.e., an application FE and a UDR.

The FE may include a UDM FE that is responsible for processing location management, subscription management, a credential, etc., and a PCF that is responsible for policy control. The UDR may store data required for functions provided by the UDM-FE and store a policy profile required by the PCF. The data stored in the UDR may include user subscription data including a subscription identifier, a security credential, AM related subscription data, and session-related subscription data, and may include policy data. The UDM-FE may support functions such as accessing subscription information stored in the UDR, authentication credential processing, user identification handling, access authentication, registration/mobility management, subscription management, and SMS management.

The UPF 104 may transfer a DL PDU received from the DN 110 to the UE 101 via the R)AN 102, and transfer an UL PDU received from the UE 101 to the DN 110 via the (R)AN 102. Specifically, the UPF 104 may support functions such as an anchor point for intra/inter radio access technology (RAT) mobility, an external PDU session point of interconnection (interconnect) to a DN, packet routing and forwarding, a UP part of implementation of policy rules and packet inspection, LI, reporting the amount of traffic used, an UL classifier for supporting routing of a traffic flow to a DN, a branching point for supporting a multi-homed PDU session, QoS handling for a UP (e.g., packet filtering, gating, and implementing UL/DL rate), verifying UL traffics (e.g., service data flow (SDF) mapping between an SDF and a QoS flow), marking a transport level packet in an UL and DL, buffering a DL packet, and triggering a DL data notification. Some or all of the functions of the UPF 104 may be supported in a single instance of a single UPF.

The AF 107 may interoperate with a 3GPP CN in order to provide a service (e.g., supporting functions such as application effect on traffic routing, accessing network capability exposure, and interoperating with a policy framework for policy control).

The (R)AN 102 is a collective term of a new RAN that supports both an E-UTRA that is an evolved version of a 4^{th} generation (4G) RAT and NR (e.g., gNB).

The gNB may support functions such as functions for radio resource management (i.e., radio bearer control, radio admission control, connection mobility control, dynamic allocation of resources (i.e., scheduling) to a UE in an UL/DL), Internet protocol (IP) header compression, encryption of a user data stream and integrity protection, selecting an AMF in the case of attachment of a UE if routing to the AMF is not determined based on information provided to a UE, UP data routing to a UPF, control plane information routing to an AMF, connection setup and release, scheduling and transmitting a paging message (e.g., generated from an AMF), scheduling and transmitting system broadcast information (e.g., generated from an AMF or operating and maintenance (O&M)), measuring for mobility and scheduling and configuring a measurement report, transport level packet marking in a UL, SM, supporting network slicing, QoS flow management and mapping to a data radio bearer, supporting a UE in an inactive mode, distributing an NAS message, an NAS node selecting function, sharing a RAN, dual connectivity, and tight interworking between an NR and a E-UTRA.

The UE 101 may include a user device, a terminal, a mobile equipment (ME), an MS, etc. In addition, the UE may be a portable device such as a laptop computer, a mobile phone, a personal digital assistant (PDA), a smartphone, and a multimedia device, or may be a nonportable device such as a personal computer (PC) and an in-vehicle device.

The NEF 111 may provide a means for safely exposing, e.g., services and capabilities for the 3^{rd} party, internal exposure/re-exposure, an AF, and edge computing, which are provided by 3GPP network functions. The NEF 111 may receive information (e.g., information based on exposed capabilities of other NFs) from the other NFs. The NEF 111 may store information received as structured data using an interface standardized based on a data storing network function. The stored information may be re-exposed to other NFs and AFs by the NEF 111, and may be used for another purpose such as analysis.

The NRF 115 may support a service discovery function. An NF discovery request may be received from an NF instance, and discovered NF instance information may be provided to the NF instance. In addition, available NF instances and services supported by the NF instances may be maintained.

In FIG. 1, for convenience of description, a reference model for a case where the UE 101 accesses a single DN 110 by using a single PDU session is illustrated, but the disclosure is not limited thereto.

The UE 101 may simultaneously access, e.g., two (DNs i.e., a local DN and a central DN), by using multiple PDU sessions. In this case, two SMFs may be selected for different PDU sessions. However, each SMF may have a capability of controlling both a local UPF and a central UPF within a PDU session.

In addition, the UE 101 may simultaneously access, e.g., two DNs, provided within a single PDU session.

The NSSF 114 may select a set of network slice instances serving the UE 101. In addition, the NSSF 114 may determine allowed network slice selection assistance information (NSSAI) and, if necessary, perform mapping for subscribed single-NSSAI (subscribed S-NSSAI). In addition, the NSSF 114 may determine configured NSSAI and, if necessary, may perform mapping for subscribed S-NSSAIs. In addition, the NSSF 114 may determine a set of AMFs used to service the UE, or determine a list of candidate AMFs by inquiring the NRF 215 according to a configuration.

The NRF 115 may support a service discovery function. The NRF 115 may receive an NF discovery request from an NF instance, and provide information on the discovered NF instance to the NF instance. In addition, available NF instances and services supported by the NF instances may be maintained.

In a 3GPP system, a conceptual link connecting between NFs in the 5GS is defined as a reference point. Reference points included in the 5GS architecture represented in FIG. 1 are illustrated below, and more reference points other than the reference points described below may be defined in the 5GS architecture.
N1: a reference point between a UE and an AMF
N2: a reference point between a (R)AN and an AMF
N3: a reference point between a (R)AN and a UPF
N4: a reference point between an SMF and a UPF
N5: a reference point between a PCF and an AF
N6: a reference point between a UPF and a DN
N7: a reference point between an SMF and a PCF
N8: a reference point between a UDM and an AMF
N9: a reference point between two core UPFs
N10: a reference point between a UDM and an SMF
N11: a reference point between an AMF and an SMF
N12: a reference point between an AMF and an AUSF
N13: a reference point between a UDM and an AUSF
N14: a reference point between two AMFs
N15: a reference point between a PCF and an AMF in a case of a non-roaming scenario and a reference point between a PCF within a visited network and an AMF in a case of a roaming scenario

Hereinafter, a terminal may refer to the UE 101, and the terms “UE” and “terminal” may be interchangeably used. In such a case, unless the terminal is additionally defined, the terminal may be understood as the UE 101.

A UE route selection policy (URSP) may be used by the UE 101, and may be used to determine whether an application detected by the UE 101 can be associated with an already established PDU session, whether the application can be offloaded to a non-3GPP access existing outside the PDU session, whether the application can be routed through a proximity-service (ProSe) layer-3 UE-to-network relay existing outside the PDU session, or whether a new PDU session for the application can be established and associated. The URSP may include one or more URSP rules, and one URSP rule may include one traffic descriptor (TD) and one or more route selection components (RSCs).

A TD may include matching criteria which can identify an application detected by the terminal 101 or traffic of the application. A detailed example is as follows.
Application descriptor: information that can indicate an application of the terminal 101. For example, the application descriptor may include an application ID (APP ID) including an operating system ID (OSID) and an OS specific application ID (OSAPPID).
IP descriptor: indicates an IP address indicating a destination address of an IP packet transmitted by the terminal 101. The IP descriptor may include IP 3-tuple, i.e., an IP destination address, a port number, and a protocol.
Domain descriptor: represents a destination address of a server for connecting the terminal 101, in the form of, for example, a fully qualified domain name (FQDN).
Non-IP descriptor: information that can designate a receiving destination of non-IP data.
DN name (DNN): a name of the DN.
Connection capability (CC): corresponds to type information that can designate characteristics of connected traffic, and may have a value such as an IP multimedia subsystem (IMS), a multimedia message service (MMS), and Internet.

An RSC may include PDU session property information for determining a PDU session to be associated with an application of application traffic when a traffic descriptor capable of identifying the application detected by the terminal 101. A detailed example is as follows.
SSC Mode Selection: may have a value such as SSC Mode 1, SSC Mode 2, and SSC Mode 3 for an element for designating SSC.
Network slice selection: information that can designate network slicing.
DNN selection: a DN name.
PDU session type selection: an element that can designate the type of PDU session which can designate IPv4, IPv6, IPv4v6, Ethernet, or Non-IP.
Non-seamless offload indication: indicates that traffic of the application can be offloaded through non-3GPP access existing outside the PDU session.
ProSe layer-3 UE-to-network relay offload indication: indicates that traffic of the application can be offloaded through ProSe layer-3 UE-to-network relay existing outside the PDU session.
Access type preference: an element referring to whether a PDU session is a PDU session connected through 3GPP access, a session connected through non-3GPP access, or a session supporting multi-access connection using both 3GPP access and non-3GPP access.
PDU session pair ID: an element referring to an identifier identifying that application traffic is shared to a redundant PDU session.
Redundancy sequence number (RSN): an element referring to an identifier used during redundant transmission.

Multiple URSP rules may be divided into a policy section (PS) of a UE policy container. In an embodiment of the disclosure, the multiple URSP rules may be divided into multiple PSs not exceeding a maximum allowed transmission size of an NAS layer and included. One URSP rule may fail to be divided into two PS and included. One complete URSP rule may be included in one PS.

The URSP rules may have priorities for each rule. According to an embodiment, each URSP rule may include a URSP rule identifier which can identify the URSP rule. More specifically, the URSP rule identifier may indicate a traffic parameter enabling the terminal 101 to distinguish a terminal application.

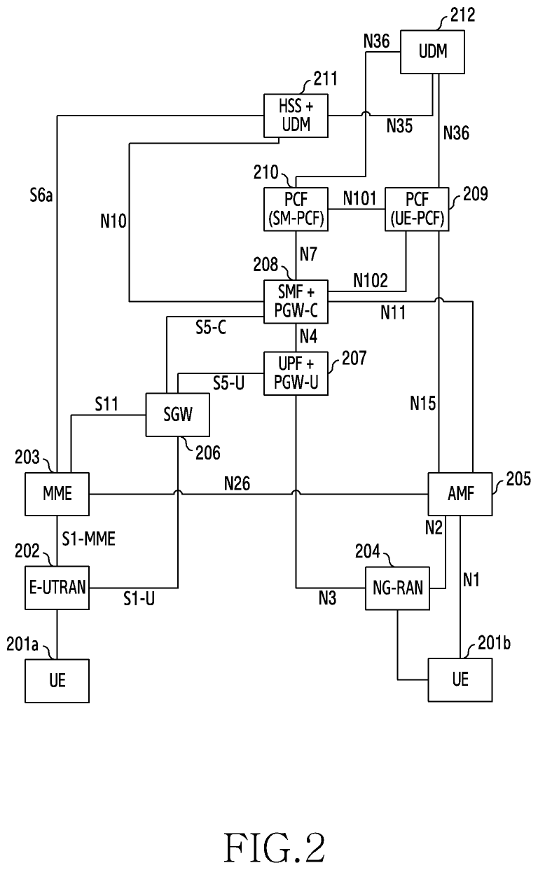

FIG. 2 illustrates a network structure and an interface of a wireless communication system supporting interworking between an EPS and a 5GS according to an embodiment. Among network entities of FIG. 2, for a basic function for a corresponding entity, the description in FIG. 1 can be referred to.

Referring to FIG. 2, a 5GS may include an NR BS (NG-RAN or gNB) for radio access of a terminal (UE) 201b, and an AMF 205. Although not illustrated in FIG. 2, the 5GS may include the SMF, the UPF, the PCF, the NSSF, the UDM, the UDR, etc., e.g., as described in FIG. 1.

An EPS may include an E-UTRA BS (evolved universal mobile telecommunications system (UMTS) terrestrial RAN (E-UTRAN) or eNB) 202, a mobility management entity (MME) for managing mobility of a terminal (UE) 201a, a serving gateway 206 that is responsible for a UP of the terminal (UE) 201a and a packet DN gateway (PGW) (wherein PGW may include a PGW-user (U) and a PGW-control (C)), a policy and charging rule function (PCRF) for managing policy information, a home subscriber server (HSS) for managing subscription information of the terminal (UE) 201a, etc.

According to an embodiment, the AMF and the MME may be NFs for managing AM of a radio network for the terminal. The SMF, SGW, and the PGW may be NFs for managing a session for the terminal, and session information may include QoS information, chagrining information, and information on packet processing. In addition, the UPF and the PGW may be NFs for processing UP traffic (e.g., user plane traffic), and may be controlled by the SMF and the SGW. The PCF and the PCRF may be NFs for managing an operator policy and/or PLMN policy for providing a communication service in a wireless communication system. Additionally, the PCF may be divided into a PCF (i.e., UE-PCF) that is responsible for an AM policy and a UE policy, and a PCF (i.e., SM-PCF) that is responsible for an SM policy. The AM/UE policy PCF (i.e., AM-PCF/UE-PCF) and the SM policy PCF (i.e., SM-PCF) may be logically or physically separated NFs, or may be logically or physically a single NF. The UDM and the HSS may be NFs for storing and managing UE subscription information. The UDR may be an NF or a DB for storing and managing data. The UDR 212 may store UE subscription information and provide the UDM with the UE subscription information. In addition, the UDR 212 may store operator policy information and provide the PCF with the operator policy information. The NSSF may be an NF for performing a function of selecting a network slice instances for servicing the terminal, or determining NSSAI.

The “instance” may mean a state in which an NF exists in the form of a software code and for performing of a function of the NF in a physical computing system (for example, a specific computing system existing on a CN), a physical and/or logical resource is allocated from the computing system and the function of the NF can be executed. For example, each of an ANF instance, an SMF instance, an NSSF instance, etc. may mean a state in which a physical and/or logical resource can be allocated from a specific computing system existing on a CN and used for operations of an AMF, an SMF, and an NSSF. Accordingly, a case where the physical AMF, SMF, and NSSF devices exist and the AMF instance, the SMF instance, and the NSSF instance which uses the physical and/or logical resource allocated from a specific computing system existing on the network for the operations of the AMF, the SMF, and the NSSF may perform the same operation.

The UDM of the 5GS and the HSS of the EPS may be configured as one combo node (or referred to as a combination node, or referred to as UDM+HSS or HSS+UDM) 211. A UDM+HSS node 211 may store UE subscription information. The SMF of the 5GS and the PGW-C of the EPS may be configured as one combo node (referred to as SMF+PGW-C or PGW-C+SMF) 208. The PCF of the 5GS and the policy control and charging rule function (PCRF) of the EPS may be configured as one combo node (referred to as a PCF+PCRF or PCRF+PCF). The UPF of the 5GS and the PGW-U of the EPS may be configured as one combo node (referred to as UPF+PGW-U or PGW-U+UPF) 207. The terminal 201a may access the MME 203 of the EPS through the E-UTRA BS 202 to use the EPS network service. In addition, the terminal 201b may access the AMF 205 of the 5GS through the NR BS 204 to use the 5GS network service.

In FIG. 2, for convenience of description, different reference numerals are used for the terminal having accessed the EPS and the terminal having accessed the 5GS, but the terminals 201a and 201b may be the same terminal. This is for indicating that the terminal is a terminal which can access both the EPS and the 5GS.

In addition, the EPS and the 5GS may be referred to as a first network and a second network, respectively, or may be referred to as a second network and a first network, respectively.

A single NF or network entity may simultaneously support different network systems, and such an NF, network, node, or network entity may be referred to as the above-described combo node, combo NF, combo entity, combined node, combined NF, combined entity, interworking node, interworking NF, interworking network entity, etc. In addition, the function of the NF illustrated as the combo node may be also implemented through interworking between two or more network entities. In addition, for convenience of illustration and description, an NF for simultaneously supporting different network systems may be indicated using “+” symbol or “/” symbol. For example, when the SMF and the PGW-C are configured as one combo node, it may be represented as PGW-C/SMF, PGW-C+SMF, SMF/PGW-C, or SMF+PGW-C.

The terminals 201a and 201b may access a DN (e.g., an IP network for providing an Internet service) through the 5GS and the EPS and establish a session. In this case, the terminal may distinguish each DN by using an identifier such as a DNN or an access point name (APN). To distinguish the DN, the DNN may be used in the 5GS and the APN may be used in the EPS. When the terminal connects a session with the network system, the DNN and the APN may be used for determining an NF related to a UP, an interface between NFs, an operator policy, etc. The DNN and the APN may be understood as equivalent information, and may transfer the same information. For example, the DNN may be used for selecting an SMF and a UPF for a PDU session, and may be used for selecting an interface (e.g., N6 interface) between the DN and the UPF for the PDU session. In addition, the DNN may be used for determining a mobile communication operator policy to be applied to the PDU session.

In the following embodiments, a combo node such as a UDM+HSS node, a PCF+PCRF node, an SMF+PGW-C node, or a UPF+PGW-C node may be indicated while omitting the term “node” for convenience of description. In addition, in the following embodiments, a message defined in one embodiment may be applied to have the same meaning also in another embodiment using the same message.

The PCF may be divided into an SM-PCF 210 that is responsible for an SM policy and a UE-PCF 209 that is responsible for a mobility management policy (AM policy) and/or a UE policy. The SM-PCF 210 may be connected to the SMF (SMF+PGW-C in FIG. 2) 208 through an N7 interface, and cannot be connected to the AMF 205. In other words, the SM-PCF 210 cannot support an N15 interface. In addition, the UE-PCF 209 may be connected to the AMF 205 through the N15 interface, and cannot be connected with the SMF (SMF+PGW-C in FIG. 2) 208. In other words, the UE-PCF 209 cannot support the N7 interface. The SM-PCF 210 and the UE-PCF 209 may be physically and/or logically located in one device or once PCF, but may be distinguished as different PCF instances.

The UE policy provided to the UE by the PCF may include AN discovery & selection policy (ANDSP), a UE route selection policy, a V2X policy, and/or a ProSe policy. Information or a parameter included in each policy may include:
ANDSP: includes policy information required when a UE selects a non-3GPP AN.
URSP: includes policy information required to route traffic escaping from a UE.
V2X policy (V2XP): includes policy information for providing a configuration parameter required when a UE performs V2X communication.
ProSe policy (ProSeP): includes policy information for providing a configuration parameter required when a UE performs ProSe direct discovery, ProSe direct communication, ProSe UE-to-network relay, and remote UE communication.

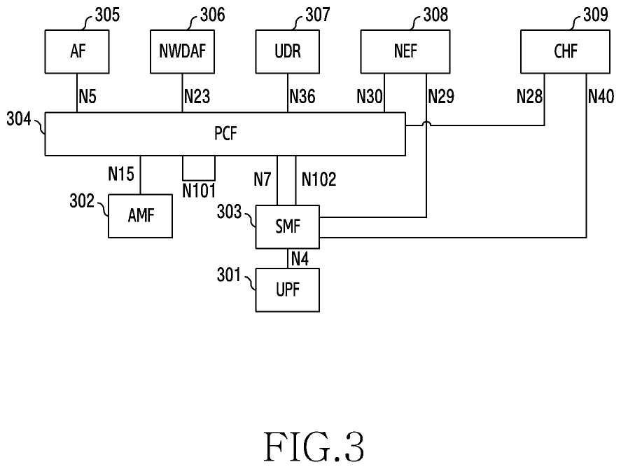

FIG. 3 illustrates a network structure and an interface related to a policy control and charging control system of a 5GS according to an embodiment. For basic functions of corresponding entities in FIG. 3, descriptions in FIGS. 1 and 2 can be referred to, respectively.

Referring to FIG. 3, a PCF 304 may take a role of a united control framework for controlling a network operation.

An AF 305 may provide session-related information to a charging function (CHF) to support rule generation.

A network data analysis function (NWDAF) 306 may collect data from a random NF included in a CN. In this case, the NWDAF 306 and a counterpart NF should belong to the same public land mobile network (PLMN).

A UDR 307 may provide the UDM, the PCF 304, the NEF 308, etc., with subscription information data, policy data, structured data for exposure, and application data.

An NEF 308 may take a role of safely exposing a network service and function.

A CHF 309 may communicate with a 5G CN and provide a charging system related to the use of network resources.

Hereinafter, each reference point illustrated in FIG. 3 is described in more detail.

First, a single PCF instance cannot simultaneously support N15 and N7.
N15: a reference point between an AMF 302 and a PCF 304
N7: a reference point between an SMF 303 and a PCF 304
N4: a reference point between an SMF 303 and a UPF 301
N5: a reference point between an AF 305 and a PCF 304
N23: a reference point between an NWDAF 306 and a PCF 304
N36: a reference point between a UDR 307 and a PCF 304
N30: a reference point between an NEF 308 and a PCF 304
N29: a reference point between an NEF 302 and an SMF 303
N28: a reference point between a CHF 309 and a PCF 304
N40: a reference point between a CHF 309 and an SMF 303
N101: a reference point between a PCF instance supporting N15 and a PCF instances supporting N7
N102: a reference point between an SMF and PCF supporting N15

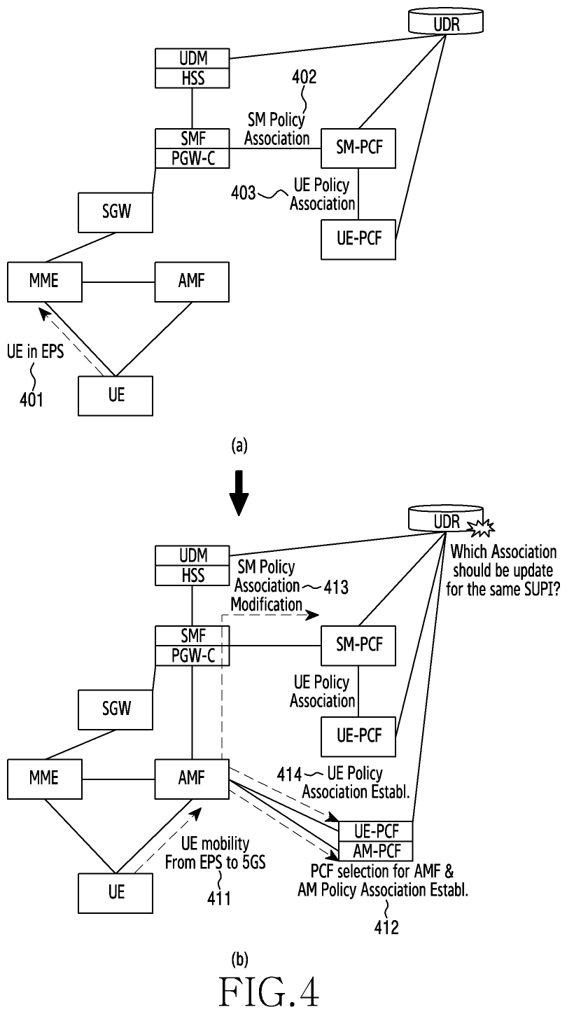

FIG. 4 illustrates a network access procedure in a wireless communication system supporting interworking between an EPS and a 5GS supporting UE policy management according to an embodiment.

Referring to FIG. 4, part (a) illustrates a system structure and a procedure of accessing a CN through an EPS entity (i.e., network entity in the EPS) by a UE, and part (b) illustrates a system structure and a procedure for a process in which a UE moves access to a CN from the EPS to the 5GS.

The system structure illustrated in FIG. 4 is based on the structure of the wireless communication system supporting interworking between the EPS and the 5GS, the structure being illustrated in FIG. 2, and for the part that is not illustrated or is omitted to be described, the illustration and the description of FIG. 2 can be referred to.

According to the configuration and/or definition on a system, not all the operations described below are necessarily included, and some operations can be omitted.

Referring to part (b) of FIG. 4, a system structure and a procedure of accessing a CN through an EPS entity by a UE in a wireless communication system supporting interworking between an EPS and a 5GS supporting UE policy management is described.

In operation 401, the UE may access the CN through an MME.

In operations 402 and 403, when the UE and/or the CN can transmit/receive a UE management policy to the UE through the EPS entity, the SMF+PGW-C may request an establishment and management procedure of UE policy association from the UE-PCF through the SM-PCF by using SM policy association established with the SM-PCF.

Referring to part (b) of FIG. 4, a system structure and a procedure for a process in which a UE moves access to a CN from an EPS to a 5GS in a wireless communication system supporting interworking between the EPS and the 5GS supporting UE policy management is described in detail.

In operation 411, the UE may access the CN of the 5GS through an AMF.

In operation 412, in a 5GS registration procedure of the UE, the AMF may perform PCF selection for the AMF to manage an access management policy, and a selected PCF, as an AM-PCF, may establish AM policy association with the AMF. Here, the AM-PCF may be the same PCF as to a UE-PCF for establishing UE policy association to transmit/receive UE policy information for the UE by the AMF. The same PCF may mean a PCF which can be identified using the same PCF ID and/or the same PCF instance ID.

In operation 413, in the 5GS registration procedure of the terminal, when the AMF recognizes that the UE has moved to the 5GS after accessing the CN through the EPS, the AMF may request a PDU session modification procedure from the SMF+PGW-C which manages a session (e.g., packet DN (PDN) connection) used by the UE in the EPS. The SMF+PGW-C may acquire information related to UE management policy association through the SM-PCF by using an SM policy association meditation procedure, and transfer the same to the AMF.

In operation 414, in the 5GS registration procedure of the UE, the AMF may establish UE policy association with the UE-PCF to transmit/receive UE policy information for the UE as described in operation 412 after notifying the UE of acceptance of a registration request of the UE. In operation 412, if the AM-PCF (referred to as PCF #1) selected as a PCF for the AMF is different from the UE-PCF (referred to as PCF #2 which corresponds to the UE-PCF mentioned in operation 413) which has managed the UE policy during the access by the UE through the EPS, the UDR may be notified of information related to the UE policy from one or more PCFs that are responsible for UE policy management for the same UE. Here, the same UE may mean a UE identified using the same subscription permanent identifier (SUPI). When a change (e.g., generation, modification, and deletion) is made to the UE management policy of the UE, the UDR may need to determine a PCF to be notified of the change from among the one or more PCFs. In addition, the UDR may need to determine a PCF corresponding to a PCF that is responsible for post management if the UE management policy has failed to be normally transferred to the UE, from among the one or more PCFs. In addition, the UDR may need to determine a PCF having transmitted a UE management policy having a higher priority from among the one or more PCFs.

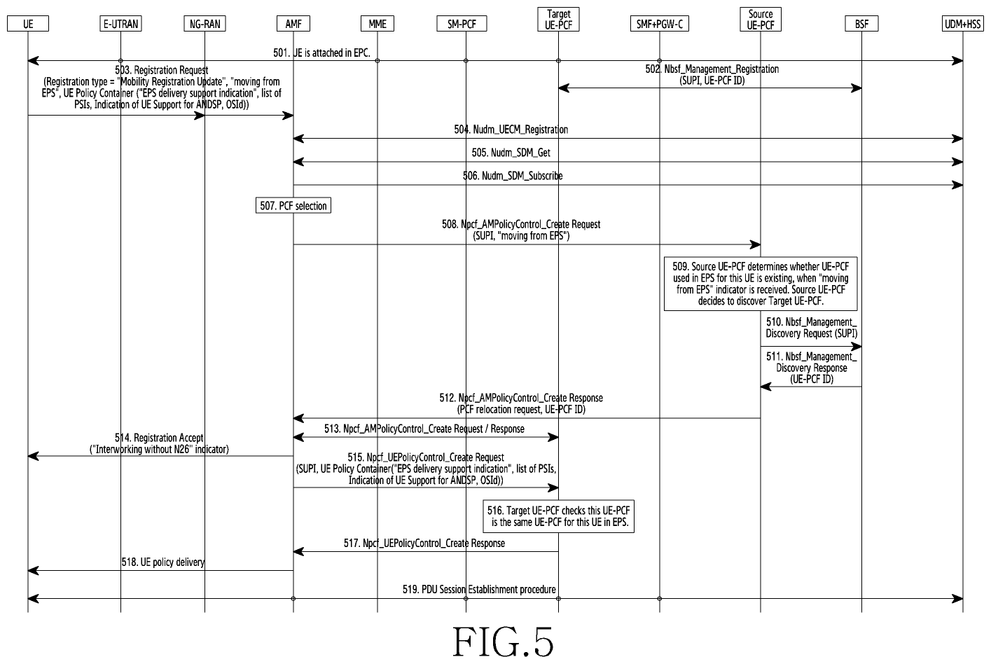

FIG. 5 is a signal flow diagram illustrating a procedure for resuming a connection with a PCF used in an EPS when a UE moves CN access from the EPS to a 5GS in a wireless communication system supporting interworking between the EPS and the 5GS according to an embodiment. More specifically, FIG. 5 illustrates a method of searching for a UE-PCF ID used in the EPS during a 5GS AM policy association establishment procedure. For example, FIG. 5 includes the system described in FIGS. 1 to 4, and the details thereof may have been omitted from the description of FIG. 5.

Referring to FIG. 5, in step 501, a UE may be attached to an EPS. The UE may be attached to an MME through an E-UTRAN, and the MME may be attached to an SMF+PGW-C. The SMF+PGW-C may establish SM policy association with an SM-PCF to manage an SM policy. The SMF+PGW-C may establish UE policy association with a UE-PCF (target UE-PCF) to manage a UE policy through the SM-PCF. The MME may be registered in a UDM+HSS, as a network entity that is responsible for registration and mobility management, and exchange subscription data required for the registration and mobility management of the UE.

In step 502, the UE-PCF (target UE-PCF) may be registered in a binding support function (BSF), as a network entity that is responsible for the UE policy of the UE. As described in step 501 above, when UE policy association for the UE attached to the EPS is established, the UE-PCF may provide the BSF with an identifier of the corresponding UE and its own identifier and request registration. An Nbsf_Management_Registration request message may be used for the registration request, a SUPI may be included as the UE identifier, and a UE-PCF ID may be included as an identifier of the UE-PCF.

In step 503, the UE may move to a 5GS to request registration. The UE may transmit a registration request to an AMF through an NG-RAN. The registration request may include at least one of “mobility registration update” corresponding to a registration type, an indicator (hereinafter, referred to as a “moving from EPS indicator”) notifying of moving from the EPS to the 5GS, or a UE policy container including UE policy and related information stored by the UE. Some information included in the registration request may be provided to the NG-RAN. The UE policy container may include at least one of an indicator (hereinafter, referred to as an “EPS delivery support indication”) notifying that the UE is a UE capable of receiving UE policy information through an EPS network entity, a PSI list, an indicator (hereinafter, referred to as an “indication of UE support for ANDSP”) notifying of whether the ANDSP of the UE is supported, or an identifier (hereinafter, referred to as an “OSId”) of an OS supported by the UE.

In step 504, the AMF may be registered in the UDM+HSS, as a network entity that is responsible for UE registration and mobility management. The AMF may use an Nudm_UECM_Registration request message in requesting registration from the UDM+HSS. The UDM+HSS may use an Nudm_UECM_Registration request message in providing the AMF of subscription information.

In step 505, the AMF may acquire subscription information required the registration and mobility management by requesting the same from the UDM+HSS. The AMF may use an Nudm_SDM_Get request message in requesting subscription information from the UDM+HSS. The UDM+HSS may use an Nudm_SDM_Get response message in providing the AMF with subscription information.

In step 506, in case that there is a change in the subscription information required for registration and mobility management of the UE, the AMF may request the UDM+HSS to notify of the change. The AMF may use an Nudm_SDM_Subscribe message in requesting the notification on the change of the subscription information from the UDM+HSS.

In step 507, the AMF may select a PCF (source UE-PCF) for AM policy management.

In step 508, the AMF may request AM policy association from the PCF (source UE-PCF) selected in step 507, and request AM policy information. The AMF may use an Npcf_AMPolicyControl_Create request message. The AMF may provide the PCF with a SUPI. The AMF may additionally provide the PCF with the moving from EPS indicator. As an example of a method of determining, by the AMF, whether to additionally provide the PCF with the moving from EPS indicator, if the registration request of step 3 includes the registration type indicating the “mobility registration update” and the UE policy container, or the registration type indicating the “mobility registration update”, the moving frame EPS indicator, and the UE policy container, the AMF may determine to additionally provide the PCF with the moving from EPS indicator. Accordingly, if the AMF may determine that the UE moved from the EPS to the 5GS has already stored the UE policy before step 3, the AMP may determine to additionally provide the moving from EPS indicator, and as information used as the grounds for determination, information other than the registration type, the moving from EPS indicator, and the UE policy container may be used alone or together with all or some of the registration type, the moving from EPS indicator, and the UE policy container.

In step 509, the source UE-PCF may determine that whether the AMF of step 508 has maintained UE policy association through the EPS entity for the SUPI having requested the AM policy. As an example of method of determining whether the UE policy association through the EPS entity has maintained, there may be a method of identifying whether the source UE-PCF has maintained the UE policy association with the SM-PCF or the SM+PGW-C for the corresponding SUPI. In case that the UE policy association through the EPS entity has been maintained, the source UE-PCF may determine that the source UE-PCF can also support UE policy management in also in the 5GS. According to the request in step 508 above, the source UE-PCF may determine the AM policy information and provide the same to the AMF, and may determine UE policy information and provide the same to the UE through the AMF when later the AMF requests the UE policy association and the UE policy information. In case that the UE policy association through the EPS entity has not been maintained, whether the UE-PCF used in the EPS needs to be searched for may be determined. For example, in step 8 above, when the AMF has provided the moving from EPS indicator or when the AMF has identified based on another information provided in step 8 above that the UE has moved from the EPS to the 5GS, the source UE-PCF may determine that the UE-PCF used in the EPS needs to be searched for.

In step 510, as described in step 509, when determining to search for the UE-PCF used in the EPS, the source UE-PCF may request, from the BSF, an identifier of the UE-PCF used in the EPS. The source UE-PCF may use an Nbsf_Management_Discover request message, and provide the SUPI as an identifier of the UE.

In step 511, the BSF may provide the AMF with the identifier of the UE-PCF registered as a network entity that is responsible for UE policy management for the corresponding SUPI according to the request of the source UE-PCF in step 510. For example, the BSF may provide the AMF with the target UE-PCF ID registered in step 502 above. The BSF may use an Nbsf_Management_Discover response message, and a UE-PCF ID may be provided as the identifier of the UE-PCF.

In step 512, instead of establishing the AM policy association and providing the AM policy information, for the request of the AMF in step 508 above, the source UE-PCF may provide the UE-PCF ID received from the BSF in step 511 above, so as to request the AMF to perform a procedure required for AM policy and UE policy management with a PCF indicated by the corresponding UE-PCF ID. The source UE-PCF may additionally provide the AMF with a PCF relocation request indicator.

In step 513, in case that the AMF receives the PCF relocation request indicator and the UE-PCF ID, or the UE-PCF ID in step 512, the AMF may request AM policy association and AM policy information from a target UE-PCF corresponding to the PCF indicated by the corresponding UE-PCF ID. The AMF may use an Npcf_AMPolicyControl_Create request message. The AMF may provide the PCF with the SUPI. The PCF may determine the AM policy and provide the AMF with the AM policy information. The PCF may use an Npcf_AMPolicyControl_Create response message. The AMF may store AM policy information received from the PCF and apply the same to registration and mobility management of the UE.

In step 514, in case that accepting the 5GS registration request of the UE, the AMF may notify the UE of the acceptance of the registration request. The AMF may transmit the registration accept message to the UE, and if there is no connection using an N26 interface between the AMF and the MME, may include an indicator (hereinafter, referred to as an “interworking without N26 indicator”) between the AMF and the MME.

In step 515, the AMF may request the UE policy association and the UE policy information from the PCF (target UE-PCF) of step 513 above. The AMF may use the Npcf_UEPolicyControl_Create request message. The AMF may transfer the SUPI and the UE policy container received from the UE in step 502 to the PCF.

In step 516, for the SUPI indicated by the request of the AMF in step 515, the target UE-PCF may determine whether the target UE-PCF has been responsible for management of the UE policy in the EPS. For example, in case that the target UE-PCF has stored the UE policy information for the corresponding UE, has maintained the UE policy association for the corresponding UE, or has maintained the UE policy association for the corresponding UE with the SMF-PCF or the SMF-PGW-C, the target UE-PCF may determine that the target UE-PCF has been responsible for management of the UE policy in the EPS. In case that the target UE-PCF determines that the target UE-PCF has been responsible for management of the UE policy in the EPS, the target UE-PCF may accept the UE policy association establishment request of the AMF of step 515 and determine the UE policy.

In step 517, the source UE-PCF may transmit a response to the UE policy association establishment request to the AMF, and provide the AMF with the UE policy container including the UE policy information. The AMF may use the Npcf_UEPolicyControl_Create response message. After the UE policy information has been successfully transferred to the UE, the source UE-PCF may perform a procedure of releasing the UE policy association which has been maintained with the EPS entity (for example, the SM+PCF or the SMF+PGW-C).

In step 518, the AMF may transfer the UE policy container received in step 518 to the UE.

In step 519, the UE may be attached to the AMF, the SMF+PGW-C, and the UDM+HSS through the NG-RAN to establish a PDU session. The SM-PCF may manage the SM policy of the UE attached to the 5GS. The target UE-PCF may manage the UE policy of the UE attached to the 5GS, and the transfer of the UE policy may be performed through the AMF.

Additionally or alternatively, as the identifier of the UE-PCF in step 502, an address of the UE-PCF may be included. For example, an endpoint address or a uniform resource identifier (URI) may be included as the address of the UE-PCF.

In step 511, in providing the target UE-PCF ID, the BSF may provide the AMF with the address of the target UE-PCF. For example, the endpoint address or the URI may be provided as the address of the target UE-PCF.

In step 512, in providing the UE-PCF ID received from the BSF in step 511, the source UE-PCF may provide the AMF with the address of the target UE-PCF. For example, the endpoint address or the URI may be provided as the address of the target UE-PCF. The source UE-PCF may additionally provide the AMF with a PCF relocation request indicator. When supporting a redirection function using address information, the source UE-PCF may provide the AMF with the endpoint address or the URI as the address of the target UE-PCF, and the PCF relocation request indicator may be omitted. The redirection function using the address information may mean communication using a hypertext transfer protocol (HTTP) redirection request/response message.

In step 513, when the UE-PCF ID received in step 512 has the form of the address including the endpoint address or the URI (i.e., when the address of the target UE-PCF is used as the target UE-PCF ID), the AMF may recognize that the redirection to the PCF indicated by the target UE-PCF address is requested even though the PCF relocation request indicator is not received together.

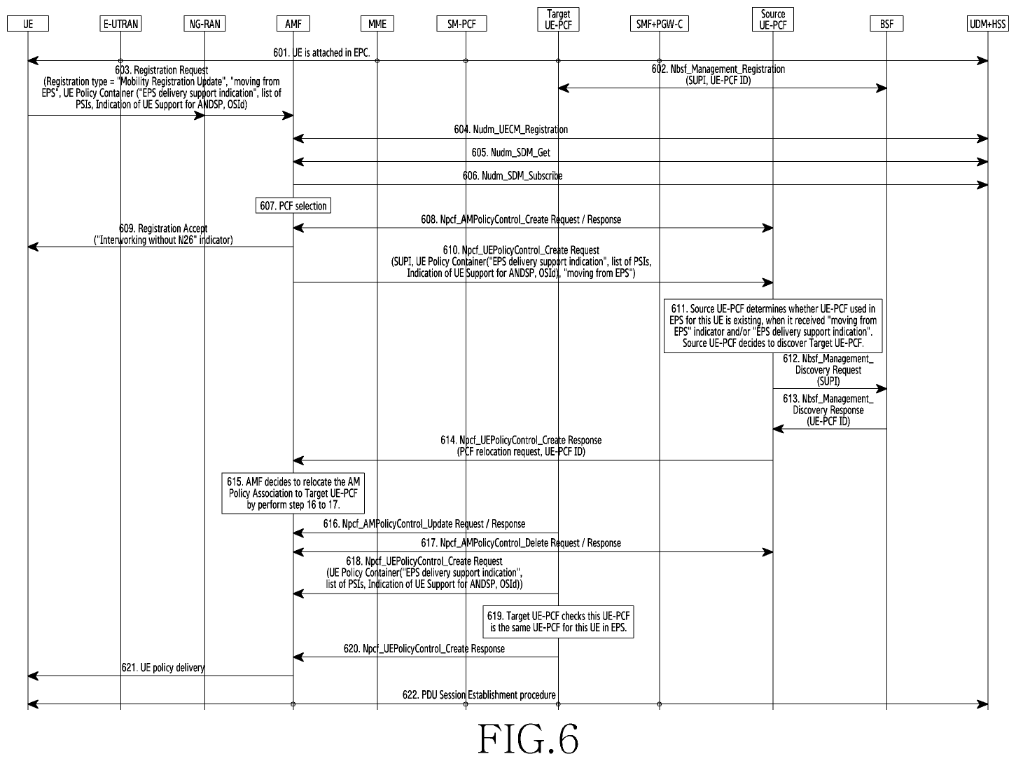

FIG. 6 is a signal flow diagram illustrating a procedure for resuming a connection with a PCF used in an EPS when a UE moves CN access from the EPS to a 5GS in a wireless communication system supporting interworking between the EPS and the 5GS according to an embodiment. More specifically, FIG. 6 illustrates a method of searching for a UE-PCF ID used in the EPS during a 5GS UE policy association establishment procedure rather than a 5GS AM policy association establishment procedure, in the procedure described in FIG. 5. The descriptions of similar steps made in FIGS. 1 to 5 may be omitted in the description of FIG. 6 below.

Referring to FIG. 6, steps 601-607 include the same contents as steps 501-507 of FIG. 5 as described above.

In step 608, the AMF may request AM policy association and AM policy information from the PCF (source UE-PCF) selected in step 607. The AMF may use an Npcf_AMPolicyControl_Create request message. The source UE-PCF may determine an AM policy and provide the AMF with the AM policy information. The source UE-PCF may use an Npcf_AMPolicyControl_Create response message. The AMF may store the AM policy information received from the PCF and apply the same to registration and mobility management of the UE.

In step 609, when accepting the 5GS registration request of the UE, the AMF may notify the UE of the acceptance of the registration request. The AMF may transmit the registration accept message to the UE, and if there is no connection using an N26 interface between the AMF and the MME, may include an indicator (hereinafter, referred to as an “interworking without N26 indicator”) between the AMF and the MME

In step 610, the AMF may request the UE policy association and the UE policy information from the PCF (source UE-PCF) selected in step 607 above. The AMF may use the Npcf_UEPolicyControl_Create request message. The AMF may transfer the SUPI and the UE policy container received from the UE in step 602 to the PCF. The AMF may additionally provide the PCF with the moving from EPS indicator. The AMF may apply the determination method described in steps 605 to 608 in determining whether to additionally provide the PCF with the moving from EPS indicator.

In step 611, the source UE-PCF may determine whether the AMF in step 610 has maintained the UE Policy association through the EPS entity for the SUPI having requested the UE policy. For example, in case that an EPS delivery support indication is included in the UE policy container provided by the AMF in step 610, the source UE-PCF may determine whether the UE policy association through the EPS entity has been maintained. As an example of a method of determining whether the UE policy association through the EPS entity has been maintained, there may be a method of identifying whether the source UE-PCF has maintained the UE policy association with the SM-PCF or the SM+PGW-C for the corresponding SUPI. In case that the UE policy association through the EPS entity has been maintained, the source UE-PCF may determine that the source UE-PCF can support the UE policy management also in the 5GS, and the source UE-PCF may determine the UE policy information according to the request in step 610 to provide the same to the UE through the AMF. If the UE policy association through the EPS entity has not been maintained, whether the UE-PCF used in the EPS needs to be searched for may be determined. For example, in step 610 above, when the AMF has provided the moving from EPS indicator or when the AMF has identified based on another information provided in step 610 above that the UE has moved from the EPS to the 5GS, the source UE-PCF may determine that the UE-PCF used in the EPS needs to be searched for.

In step 612, as described in step 611, in case that determining to search for the UE-PCF used in the EPS, the source UE-PCF may request, from the BSF, an identifier of the UE-PCF used in the EPS. The source UE-PCF may use an Nbsf_Management_Discover request message, and provide the SUPI as an identifier of the UE.

In step 613, the BSF may provide the AMF with the identifier of the UE-PCF registered as a network entity that is responsible for UE policy management for the corresponding SUPI according to the request of the source UE-PCF in step 612 above. For example, the BSF may provide the AMF with the target UE-PCF ID registered in step 602 above. The BSF may use an Nbsf_Management_Discover response message, and a UE-PCF ID may be provided as the identifier of the UE-PCF.

In step 614, instead of establishing the AM policy association and providing the AM policy information, for the request of the AMF in step 610 above, the source UE-PCF may provide the UE-PCF ID received from the BSF in step 612 above, so as to request the AMF to perform a procedure required for AM policy and UE policy management with a PCF indicated by the corresponding UE-PCF ID. The source UE-PCF may additionally provide the AMF with a PCF relocation request indicator.

In step 615, in case that the AMF receives the PCF relocation request indicator and the UE-PCF ID, or the UE-PCF ID in step 614, the AMF may determine to perform a procedure (corresponding to step 616 and 617 below) of relocating the AM policy association established with the source UE-PCF in step 608 above to the target UE-PCF and performing a procedure (corresponding to step 618 below) of requesting UE policy association establishment. If the AMF has not performed step 608 according to the configuration of the network, the procedure of relocating the AM policy association can be omitted.

In step 616, the AMF may request the AM policy information and the AM policy association performed in step 608 from the target UE-PCF. The AMF may use an Npcf_AMPolicyControl_Create request message. The target UE-PCF may determine the AM policy and provide the AMF with the AM policy information. The target UE-PCF may use an Npcf_AMPolicyControl_Create response message. The AMF may store AM policy information received from the PCF and apply the same to registration and mobility management of the UE.

In step 617, the AMF may request the source UE-PCF to release the AM policy association established in step 608 above. The AMF may use an Npcf_AMPolicyControl_Delete request message. The source UE-PCF may delete the stored AM policy information and AM policy association-related information and respond to the release request of the AMF. The source UE-PCF may use an Npcf_AMPolicyControl_Delete response message. The AMF may delete the AM policy information received from the source UE-PCF.

The same contents as for step 618-622 of FIG. 6 may be applied to steps 515-519 of FIG. 5.

Additionally or alternatively, in step 602, an address of the UE-PCF may be included as the identifier of the UE-PCF. For example, an endpoint address or a URI may be included as the address of the UE-PCF.

In step 613, in providing the target UE-PCF ID, the BSF may provide the AMF with the address of the target UE-PCF. For example, the endpoint address or the URI may be provided as the address of the target UE-PCF.

In step 614, in providing the UE-PCF ID received from the BSF in step 611, the source UE-PCF may provide the AMF with the address of the target UE-PCF. For example, the endpoint address or the URI may be provided as the address of the target UE-PCF. The source UE-PCF may additionally provide the AMF with the PCF relocation request indicator. When a redirection function using address information is supported, the source UE-PCF may provide the AMF with the endpoint address or the URI as the address of the target UE-PCF, and a PCF relocation request indicator may be omitted. The redirection function using the address information may mean communication using an HTTP redirection request/response message.

In step 615, when the UE-PCF ID received in step 614 has the form of the address including the URI or the endpoint address (i.e., when the address of the target UE-PCF is used as the target UE-PCF ID), the AMF may recognize that redirection to the PCF indicated by the target UE-PCF address is requested even though a PCF relocation request indicator is not received together.

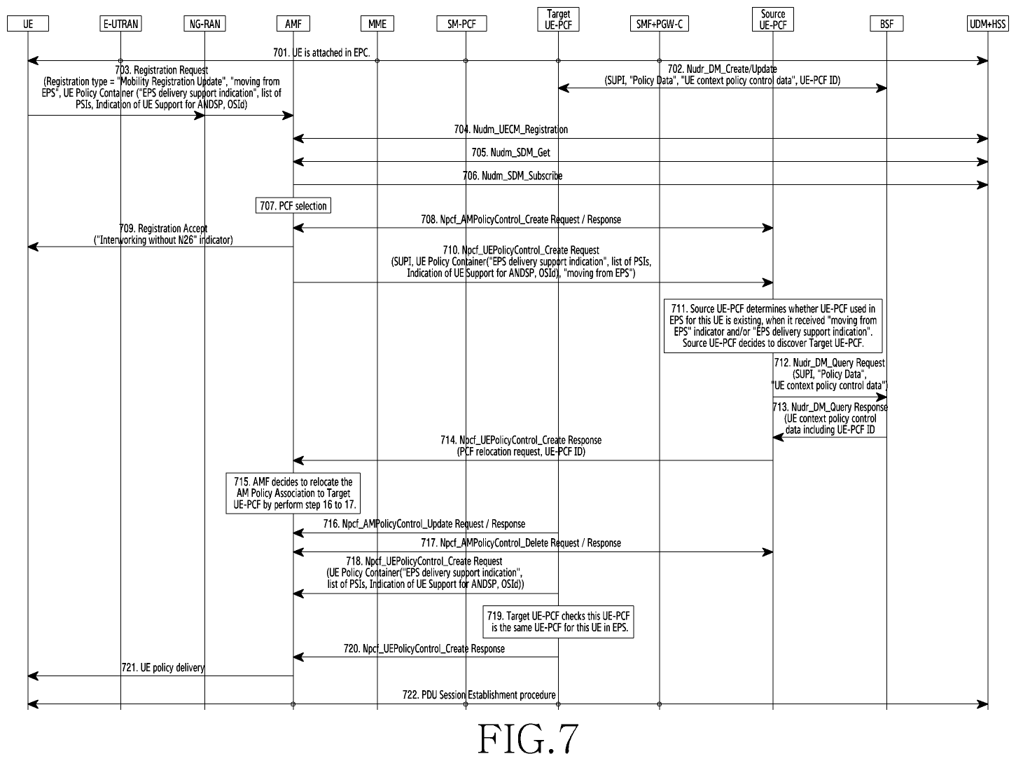

FIG. 7 is a signal flow diagram illustrating a procedure for resuming a connection with a PCF used in an EPS when a UE moves CN access from the EPS to a 5GS in a wireless communication system supporting interworking between the EPS and the 5GS according to an embodiment. More specifically, FIG. 7 illustrates a method of acquiring a UE-PCF ID used in the EPS from a UDR rather than a BSF, in the procedure described in FIG. 6.

Referring to FIG. 7, step 701 may be the same as step 601 of FIG. 6.

In step 702, the UE-PCF (target UE-PCF), as the most recent UE-PCF that is responsible for management of the UE policy in the UDR, or a UE-PCF having managed the UE policy in the EPS, may store a UE-PCF ID. The target UE-PCF may use an Nudr_DM_Create request message or an Nudr_DM_Update request message in requesting storing of the UE-PCF ID from the UDR. “Policy data” may be provided as a data set value, “UE context policy control data” may be provided as a data subset value, a SUPI may be provided as a UE identifier, and a UE-PCF ID of the target UE-PCF may be provided as a UE-PCF identifier. Values other than the “policy data” and the “UE context policy data” may be used as the data set value and the data subset value, and the values are not limited to the examples above.

Steps 703-711 may be to the same as steps 603-611 of FIG. 6.

In step 712, as described in step 711 above, when determining to search for the UE-PCF used in the EPS, the source UE-PCF may request an identifier of the UE-PCF used in the EPS from the UDR. The source UE-PCF may use an Nudr_DM_Query request message. “Policy data” may be provided as a data set value, “UE context policy control data” may be provided as a data subset value, a SUPI may be provided as a UE identifier. Values other than the “policy data” and the “UE context policy data” may be used as the data set value and the data subset value, and the same values used in step 702 are used.

In step 713, according to the request from the source UE-PCF in step 712, the UDR may provide the AMF with an identifier of a UE-PCF stored as the most recent UE-PCF that is responsible for management of the UE policy for the corresponding SUPI or a UE-PCF having managed the UE policy in the EPS. For example, the target UE-PCF ID stored in step 702 may be provided to the AMF. The UDR may use an Nudr_DM_Query request message.

Steps 714-722 may be the same as steps 714-722 of FIG. 6.

Additionally or alternatively, in step 702, an address of a UE-PCF may be included an identifier (or UE-PCF ID) of the UE-PCF. For example, an endpoint address of a URI may be included as an address of the UE-PCF.

In step 713, the UDR may provide the AMF with an address of the target UE-PCF as an identifier (or target UE-PCF ID) of the target UE-PCF. For example, an endpoint address or a URI may be provided as the address of the target UE-PCF.

In step 714, in providing the UE-PCF ID received from the BSF in step 711, the source UE-PCF may provide the AMF with the address of the target UE-PCF. For example, the endpoint address or the URI may be provided as the address of the target UE-PCF. The source UE-PCF may additionally provide the AMF with a PCF relocation request indicator. When a redirection function using address information is supported, the source UE-PCF may provide the AMF with the endpoint address or the URI as the address of the target UE-PCF, and the PCF relocation request indicator may be omitted. The redirection function using the address information may mean communication using an HTTP redirection request/response message.

In step 715, when the UE-PCF ID received in step 714 has the form of the address including the URI or the endpoint address (i.e., when the address of the target UE-PCF is used as the target UE-PCF ID), the AMF may recognize that redirection to the PCF indicated by the target UE-PCF address is requested even though the PCF relocation request indicator is not received together.

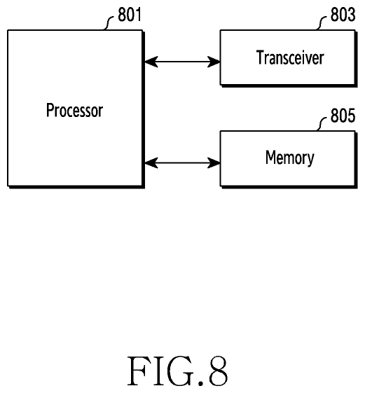

FIG. 8 illustrates a network entity according to an embodiment. For example, the network entity of FIG. 8 may be one of network entities described in the embodiments of FIGS. 1 to 7.

Referring to FIG. 8, the network entity includes a processor 801 for controlling an overall operation of the network entity, a transceiver 803 including a transmitter and a receiver, and memory 805. The disclosure is not limited to the example above, and the network entity may include more or fewer elements than the elements illustrated in FIG. 8.

The transceiver 803 may transmit or receive a signal with at least one of a UE or other network entities. The transmitted or received signal may include at least one of control information and data. When the network entity of FIG. 8 is an entity (e.g., an NF) of a CN, the signal transmitted or received between the network entity and the UE may be transmitted or received via a RAN.

The processor 801 may control an overall operation of the corresponding network entity to perform an operation according to one embodiment or a combination of two or more embodiments among the embodiments of FIGS. 1 to 7. The processor 801, the transceiver 803, and the memory 805 are not necessarily to be implemented as separate modules, and may be implemented as an element in the form such as a single chip. In addition, the processor 801 may be an application processor (AP), a communication processor (CP), a circuit, an application-specific circuit, or at least one processor. The transceiver 803 may include at least one communication interface for wiredly/wirelessly transmitting or receiving a signal to or from other network entities.

The memory 805 may store data such as a basic program, an application program, and configuration information for an operation of the corresponding network entity. In addition, the memory 805 stores data according to a request from the processor 801. The memory 805 may include a storage medium such as read only memory (ROM), random access memory (RAM), hard discs, compact disc-ROMs (CD-ROMs), and digital versatile discs (DVDs), and a combination of storage media. In addition, there may be multiple memories 805. In addition, the processor 801 may perform at least one of the above-described embodiments, based on a program for performing an operation according to at least one of the above-described embodiments, the program being stored in the memory 805.

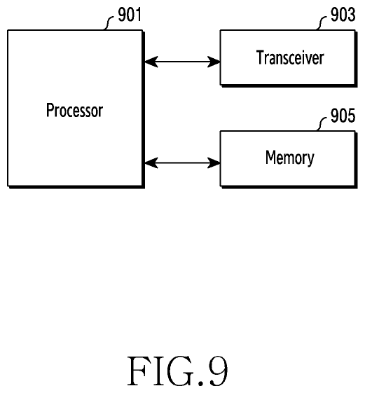

FIG. 9 illustrates a BS according to an embodiment. For example, the BS of FIG. 9 may be a RAN node as described in the embodiments of FIGS. 1 to 7.

Referring to FIG. 9, the BS includes a processor 901 for controlling an overall operation of the BS, a transceiver 903 including a transmitter and a receiver, and memory 905. The disclosure is not limited to the example above, and the BS may include more or fewer elements than the elements illustrated in FIG. 9.

The transceiver 903 may transmit or receive a signal with at least one of a UE, another BS, or a network entity. The transmitted or received signal may include at least one of control information and data.

The processor 901 may control an overall operation of the corresponding BS to perform an operation according to one embodiment or a combination of two or more embodiments among the embodiments of FIGS. 1 to 7. The processor 901, the transceiver 903, and the memory 905 are not necessarily to be implemented as separate modules, and may be implemented as an element in the form such as a single chip. In addition, the processor 901 may be an AP, a CP, a circuit, an application-specific circuit, or at least one processor. The transceiver 903 may include at least one communication interface for wiredly/wirelessly transmitting or receiving a signal to or from a UE, another BS, or a network entity.

The memory 905 may store data such as a basic program, an application program, and configuration information for an operation of the corresponding BS. In addition, the memory 905 stores data stored according to a request from the processor 901. The memory 905 may include a storage medium such as ROM, RAM, hard discs, CD-ROMs, and DVDs and a combination of storage media. In addition, there may be multiple memories 905. In addition, the processor 901 may perform at least one of the above-described embodiments, based on a program for performing an operation according to at least one of the above-described embodiments, the program being stored in the memory 905.

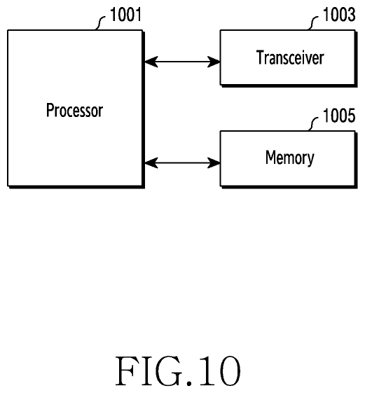

FIG. 10 illustrates a UE according to an embodiment.

Referring to FIG. 10, the UE includes a processor 1001 for controlling an overall operation of the UE, a transceiver 1003 including a transmitter and a receiver, and memory 1005. The disclosure is not limited to the example above, and the UE may include more or fewer elements than the elements illustrated in FIG. 10.

The transceiver 1003 may transmit or receive a signal with at least one of another UE, a BS, or a network entity. The transmitted or received signal may include at least one of control information and data.

The processor 1001 may control an overall operation of the corresponding UE to perform an operation according to one embodiment or a combination of two or more embodiments among the embodiments of FIGS. 1 to 7. The processor 1001, the transceiver 1003, and the memory 1005 are not necessarily to be implemented as separate modules, and may be implemented as an element in the form such as a single chip. In addition, the processor 1001 may be an AP, a CP, a circuit, an application-specific circuit, or at least one processor. The transceiver 1003 may include at least one communication interface for wiredly/wirelessly transmitting or receiving a signal to or from another UE, a BS, or a network entity.

The memory 1005 may store data such as a basic program, an application program, and configuration information for an operation of the corresponding UE. In addition, the memory 1005 stores data stored according to a request from the processor 1001. The memory 1005 may include a storage medium such as ROM, RAM, hard discs, CD-ROMs, and DVDs and a combination of storage media. In addition, there may be multiple memories 1005. In addition, the processor 1001 may perform at least one of the above-described embodiments, based on a program for performing an operation according to at least one of the above-described embodiments, the program being stored in the memory 1005.

The methods according to various embodiments described in the claims or the specification of the disclosure may be implemented by hardware, software, or a combination of hardware and software.

When the methods are implemented by software, a computer-readable storage medium for storing one or more programs (software modules) may be provided. The one or more programs stored in the computer-readable storage medium may be configured for execution by one or more processors within the electronic device. The at least one program may include instructions that cause the electronic device to perform the methods according to various embodiments of the disclosure as defined by the appended claims and/or disclosed herein.

The programs (software modules or software) may be stored in non-volatile memories including a random access memory and a flash memory, a ROM, an electrically erasable programmable ROM (EEPROM), a magnetic disc storage device, a CD-ROM, DVDs, or other type optical storage devices, or a magnetic cassette. Alternatively, any combination of some or all of them may form a memory in which the program is stored. Furthermore, a plurality of such memories may be included in the electronic device.

In addition, the programs may be stored in an attachable storage device which may access the electronic device through communication networks such as the Internet, Intranet, local area network (LAN), wide LAN (WLAN), and storage area network (SAN) or a combination thereof. Such a storage device may access the electronic device via an external port. Furthermore, a separate storage device on the communication network may access a portable electronic device.

A part or all of one or more embodiments proposed in the disclosure may be employed in combination with a part or all of one or more other embodiments and these combinations also fall within the scope of the disclosure.

The embodiments of the disclosure described and shown in the specification and the drawings are merely specific examples that have been presented to easily explain the technical contents of the disclosure and help understanding of the disclosure, and are not intended to limit the scope of the disclosure. Therefore, the scope of the disclosure should be construed to include, in addition to the embodiments disclosed herein, all changes and modifications derived on the basis of the technical idea of the disclosure. In addition, the above respective embodiments may be employed in combination, as necessary.

A method performed by an access and mobility management function (AMF) entity in a wireless communication system is provided. The method comprises receiving, from a user equipment (UE), a registration request for fifth generation system (5GS), wherein the registration request includes information on a UE policy container and an indicator that the UE is moving from an evolved packet system (EPS), transmitting, to a first policy control function (PCF) entity for the UE, a first request message for first access and management (AM) policy association based on the registration request, wherein the first request message includes the indicator and receiving, from the first PCF entity, a message including an identifier (ID) of a second PCF entity for the EPS based on the first request message.

The method further comprises transmitting, to the second PCF entity, a second request message for second AM policy association, wherein the second request message includes the information on the UE policy container, receiving, from the second PCF entity, information on a second AM policy for the UE as a response to the second request message and applying the information on the second AM policy to a management of a registration and a mobility for the UE.

The message further includes an indicator for a PCF relocation request, wherein the UE policy container includes at least one of information on a UE policy stored in the UE or information indicating that the UE is capable of receiving a UE policy via the EPS, and wherein the first request message further includes a subscription permanent identifier for the UE.

The method further comprises receiving, from the first PCF entity, information on a first AM policy as a response to the first request message, transmitting, to the first PCF entity, a third request message for first UE policy association and receiving, from the first PCF entity, the message including the ID of the second PCF entity for the EPS and an indicator for a PCF relocation request as a response to the third request message, wherein the third request message includes the information on the UE policy container.

The method further comprises transmitting, to the first PCF entity, a message for releasing the first AM policy association and deleting the information on the first AM policy.

An access and mobility management function (AMF) entity in a wireless communication system is provided. The AMF entity comprises a transceiver and a controller coupled with the transceiver and configured to receive, from a user equipment (UE), a registration request for fifth generation system (5GS), wherein the registration request includes information on a UE policy container and an indicator that the UE is moving from an evolved packet system (EPS), transmit, to a first policy control function (PCF) entity for the UE, a first request message for first access and management (AM) policy association based on the registration request, wherein the first request message includes the indicator, and receive, from the first PCF entity, a message including an identifier (ID) of a second PCF entity for the EPS based on the first request message.

The controller is further configured to transmit, to the second PCF entity, a second request message for second AM policy association, wherein the second request message includes the information on the UE policy container, receive, from the second PCF entity, information on a second AM policy for the UE as a response to the second request message, and apply the information on the second AM policy to a management of a registration and a mobility for the UE.

The message further includes an indicator for a PCF relocation request, wherein the UE policy container includes at least one of information on a UE policy stored in the UE or information indicating that the UE is capable of receiving a UE policy via the EPS, and wherein the first request message further includes a subscription permanent identifier for the UE.

The controller is further configured to receive, from the first PCF entity, information on a first AM policy as a response to the first request message, transmit, to the first PCF entity, a third request message for first UE policy association, and receive, from the first PCF entity, the message including the ID of the second PCF entity for the EPS and an indicator for a PCF relocation request as a response to the third request message, wherein the third request message includes the information on the UE policy container.

The controller is further configured to transmit, to the first PCF entity, a message for releasing the first AM policy association, and delete the information on the first AM policy.

A method performed by a first policy control function (PCF) entity in a wireless communication system is provided The method comprises receiving, from an access and mobility management function (AMF) entity, a first request message for first access management (AM) policy association based on a registration request including information on a UE policy container and an indicator that a user equipment (UE) is moving from an evolved packet system (EPS) and transmitting, to the AMF entity, a message including an identifier (ID) of a second PCF entity for the EPS based on the first request message, wherein the first request message includes the indicator.

The method further comprises transmitting, to a binding support function (BSF) entity, a message for requesting the ID of the second PCF entity for the EPS and receiving, from the BSF entity, information on the ID of the second PCF entity, wherein the message for requesting the ID of the second PCF entity includes a subscription permanent identifier (SUPI) for the UE, and wherein the information on the ID of the second PCF entity includes at least one of end point address or uniform resource identifier (URI).

The message further includes an indicator for a PCF relocation request, wherein the UE policy container includes at least one of information on a UE policy stored in the UE or information indicating that the UE is capable of receiving a UE policy via the EPS, and wherein the first request message further includes a subscription permanent identifier (SUPI) for the UE.

The method further comprises transmitting, to the AMF entity, information on a first AM policy as a response to the first request message, receiving, from the AMF entity, a third request message for first UE policy association and transmitting, to the AMF entity, the message including the ID of the second PCF entity for the EPS and an indicator for a PCF relocation request as a response to the third request message, wherein the third request message includes the information on the UE policy container.

The method further comprises receiving, from the AMF entity, a message for releasing the first AM policy association and deleting the information on the first AM policy based on the message for releasing the first AM policy association.

A first policy control function (PCF) entity in a wireless communication system, the first PCF entity comprises a transceiver and a controller coupled with the transceiver and configured to receive, from an access and mobility management function (AMF) entity, a first request message for first access management (AM) policy association based on a registration request including an indicator that a user equipment (UE) is from an evolved packet system (EPS) and information on a UE policy container, and transmit, to the AMF entity, a message including an identification (ID) of a second PCF entity for the EPS based on the first request message, wherein the first request message includes the indicator that the UE is from the EPS.

The controller is further configured to transmit, to a binding support function (BSF) entity, a message for requesting the ID of the second PCF entity for the EPS, and receive, from the BSF entity, information on the ID of the second PCF entity, wherein the message for requesting the ID of the second PCF entity includes a subscription permanent identifier (SUPI) for the UE, and wherein the information on the ID of the second PCF entity includes at least one of end point address or uniform resource identifier (URI).

The message further includes an indicator for a PCF relocation request, wherein the UE policy container includes at least one of information on a UE policy stored in the UE or information indicating that the UE is capable of receiving a UE policy via the EPS, and wherein the first request message further includes a subscription permanent identifier (SUPI) for the UE.

The controller is further configured to transmit, to the AMF entity, information on a first AM policy as a response to the first request message, receive, from the AMF entity, a third request message for first UE policy association, and transmit, to the AMF entity, the message including the ID of the second PCF entity for the EPS and an indicator for a PCF relocation request as a response to the third request message, wherein the third request message includes the information on the UE policy container.

The controller is further configured to receive, from the AMF entity, a message for releasing the first AM policy association and delete the information on the first AM policy based on the message for releasing the first AM policy association.

While the disclosure has been illustrated and described with reference to various embodiments of the present disclosure, those skilled in the art will understand that various changes can be made in form and detail without departing from the spirit and scope of the present disclosure as defined by the appended claims and their equivalents.

What is claimed is:

1. A method performed by an access and mobility management function (AMF) entity in a wireless communication system, the method comprising:
receiving, from a user equipment (UE), a registration request for fifth generation system (5GS), wherein the registration request includes information on a UE policy container and an indicator that the UE is moving from an evolved packet system (EPS);
transmitting, to a first policy control function (PCF) entity for the UE, a first request message for first access and management (AM) policy association based on the registration request, wherein the first request message includes the indicator; and
receiving, from the first PCF entity, a message including an identifier (ID) of a second PCF entity for the EPS based on the first request message.

2. The method of claim 1, further comprising:
transmitting, to the second PCF entity, a second request message for second AM policy association, wherein the second request message includes the information on the UE policy container;
receiving, from the second PCF entity, information on a second AM policy for the UE as a response to the second request message; and
applying the information on the second AM policy to a management of a registration and a mobility for the UE.

3. The method of claim 1, wherein the message further includes an indicator for a PCF relocation request,
wherein the UE policy container includes at least one of information on a UE policy stored in the UE or information indicating that the UE is capable of receiving a UE policy via the EPS, and
wherein the first request message further includes a subscription permanent identifier for the UE.

4. The method of claim 1, further comprising:
receiving, from the first PCF entity, information on a first AM policy as a response to the first request message;
transmitting, to the first PCF entity, a third request message for first UE policy association; and
receiving, from the first PCF entity, the message including the ID of the second PCF entity for the EPS and an indicator for a PCF relocation request as a response to the third request message,
wherein the third request message includes the information on the UE policy container.

5. The method of claim 4, further comprising:
transmitting, to the first PCF entity, a message for releasing the first AM policy association; and
deleting the information on the first AM policy.

6. An access and mobility management function (AMF) entity in a wireless communication system, the AMF entity comprising:
a transceiver; and
a controller coupled with the transceiver and configured to:
receive, from a user equipment (UE), a registration request for fifth generation system (5GS), wherein the registration request includes information on a UE policy container and an indicator that the UE is moving from an evolved packet system (EPS),
transmit, to a first policy control function (PCF) entity for the UE, a first request message for first access and management (AM) policy association based on the registration request, wherein the first request message includes the indicator, and
receive, from the first PCF entity, a message including an identifier (ID) of a second PCF entity for the EPS based on the first request message.

7. The AMF entity of claim 6, wherein the controller is further configured to:
transmit, to the second PCF entity, a second request message for second AM policy association, wherein the second request message includes the information on the UE policy container,
receive, from the second PCF entity, information on a second AM policy for the UE as a response to the second request message, and
apply the information on the second AM policy to a management of a registration and a mobility for the UE.

8. The AMF entity of claim 6, wherein the message further includes an indicator for a PCF relocation request,
wherein the UE policy container includes at least one of information on a UE policy stored in the UE or information indicating that the UE is capable of receiving a UE policy via the EPS, and
wherein the first request message further includes a subscription permanent identifier for the UE.

9. The AMF entity of claim 6, wherein the controller is further configured to:
receive, from the first PCF entity, information on a first AM policy as a response to the first request message,
transmit, to the first PCF entity, a third request message for first UE policy association, and
receive, from the first PCF entity, the message including the ID of the second PCF entity for the EPS and an indicator for a PCF relocation request as a response to the third request message, and
wherein the third request message includes the information on the UE policy container.

10. The AMF entity of claim 9, wherein the controller is further configured to:
transmit, to the first PCF entity, a message for releasing the first AM policy association, and
delete the information on the first AM policy.

11. A method performed by a first policy control function (PCF) entity in a wireless communication system, the method comprising:
receiving, from an access and mobility management function (AMF) entity, a first request message for first access management (AM) policy association based on a registration request including information on a UE policy container and an indicator that a user equipment (UE) is moving from an evolved packet system (EPS); and
transmitting, to the AMF entity, a message including an identifier (ID) of a second PCF entity for the EPS based on the first request message,
wherein the first request message includes the indicator.

12. The method of claim 11, further comprising:
transmitting, to a binding support function (BSF) entity, a message for requesting the ID of the second PCF entity for the EPS; and
receiving, from the BSF entity, information on the ID of the second PCF entity,
wherein the message for requesting the ID of the second PCF entity includes a subscription permanent identifier (SUPI) for the UE, and
wherein the information on the ID of the second PCF entity includes at least one of an end point address or a uniform resource identifier (URI).

13. The method of claim 11, wherein the message further includes an indicator for a PCF relocation request,
wherein the UE policy container includes at least one of information on a UE policy stored in the UE or information indicating that the UE is capable of receiving a UE policy via the EPS, and
wherein the first request message further includes a subscription permanent identifier (SUPI) for the UE.

14. The method of claim 11, further comprising:
transmitting, to the AMF entity, information on a first AM policy as a response to the first request message;
receiving, from the AMF entity, a third request message for first UE policy association; and
transmitting, to the AMF entity, the message including the ID of the second PCF entity for the EPS and an indicator for a PCF relocation request as a response to the third request message,
wherein the third request message includes the information on the UE policy container.

15. The method of claim 14, further comprising:
receiving, from the AMF entity, a message for releasing the first AM policy association; and
deleting the information on the first AM policy based on the message for releasing the first AM policy association.

16. A first policy control function (PCF) entity in a wireless communication system, the first PCF entity comprising:
a transceiver; and
a controller coupled with the transceiver and configured to:
receive, from an access and mobility management function (AMF) entity, a first request message for first access management (AM) policy association based on a registration request including an indicator that a user equipment (UE) is from an evolved packet system (EPS) and information on a UE policy container, and
transmit, to the AMF entity, a message including an identification (ID) of a second PCF entity for the EPS based on the first request message,
wherein the first request message includes the indicator that the UE is from the EPS.

17. The first PCF entity of claim 16, wherein the controller is further configured to:
transmit, to a binding support function (BSF) entity, a message for requesting the ID of the second PCF entity for the EPS, and
receive, from the BSF entity, information on the ID of the second PCF entity,
wherein the message for requesting the ID of the second PCF entity includes a subscription permanent identifier (SUPI) for the UE, and
wherein the information on the ID of the second PCF entity includes at least one of an end point address or a uniform resource identifier (URI).

18. The first PCF entity of claim 16, wherein the message further includes an indicator for a PCF relocation request,
wherein the UE policy container includes at least one of information on a UE policy stored in the UE or information indicating that the UE is capable of receiving a UE policy via the EPS, and
wherein the first request message further includes a subscription permanent identifier (SUPI) for the UE.

19. The first PCF entity of claim 16, wherein the controller is further configured to:
transmit, to the AMF entity, information on a first AM policy as a response to the first request message,
receive, from the AMF entity, a third request message for first UE policy association, and
transmit, to the AMF entity, the message including the ID of the second PCF entity for the EPS and an indicator for a PCF relocation request as a response to the third request message, and
wherein the third request message includes the information on the UE policy container.

20. The first PCF entity of claim 19, wherein the controller is further configured to:
receive, from the AMF entity, a message for releasing the first AM policy association; and
delete the information on the first AM policy based on the message for releasing the first AM policy association.
